(19) United States
(12) Patent Application Publication
(10) Pub. No.: US 2026/0125210 A1
(43) Pub. Date: May 7, 2026

(54) REAR LOADING AND UNLOADING COLLECTION VEHICLE

(71) Applicant: Shred-Tech Corporation, Cambridge (CA)

(72) Inventors: Jason Andrew Samuel OLYNIK, Cambridge (CA); Ananda Padmanaban VIRUDHAGIRI, Cambridge (CA); Matthew LAMBERT, Cambridge (CA); Yogesh Pershotam NANDWANI, Cambridge (CA)

(21) Appl. No.: 19/482,411

(22) PCT Filed: May 6, 2024
(86) PCT No.: PCT/CA2024/050612

§ 371 Date: Nov. 7, 2025

Related U.S. Application Data
(60) Provisional application No. 63/464,902, filed on May 8, 2023.
(60) Provisional application No. 63/609,190, filed on Dec. 12, 2023.

(51) Int. Cl. B65F 3/02

(52) U.S. Cl. CPC B65F 3/02; B65F 2003/023

(57) ABSTRACT

This disclosure relates to a collection vehicle that may be loaded and unloaded to and from the rear of the vehicle. A cargo compartment of the collection vehicle is divided into two side-by-side sections. One of the sections operates as a loading section and the other section operates as an unloading section. The loading section includes a bin tipper at the rear end of the loading section adjacent to an unloading access at a rear end of the unloading section. Inside the loading section, a cargo handling ramp is positioned onto which contents of a tipped bin are dumped. As cargo is dumped from a tipped bin, the cargo falls onto the cargo handling ramp and then slides or falls down the ramp into the unloading section. Cargo deposited into the unloading section may then be unloaded through the unloading access.

### BACKGROUND

Collection vehicles are used for a variety of purposes, for example, paper collection, garbage collection, recycling materials collection, and the like. Typical collection vehicles are loaded through a side access point and are subsequently unloaded through a rear access point, or alternatively, such vehicles are loaded through a rear access point and are subsequently unloaded through a side access point.

### DETAILED DESCRIPTION OF DRAWINGS

The present systems and methods for a collection vehicle are described in detail below with reference to these figures.

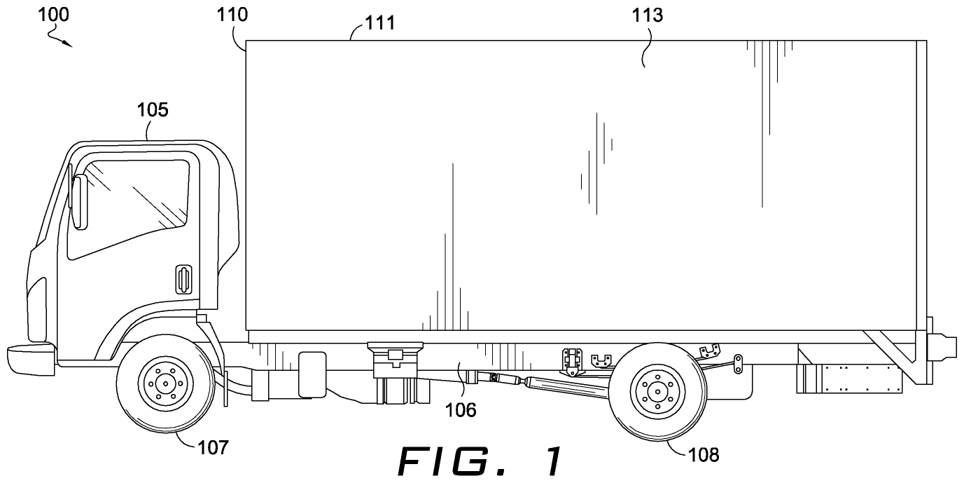

FIG. 1 depicts a side elevation view of a collection vehicle, in accordance with examples of this disclosure.

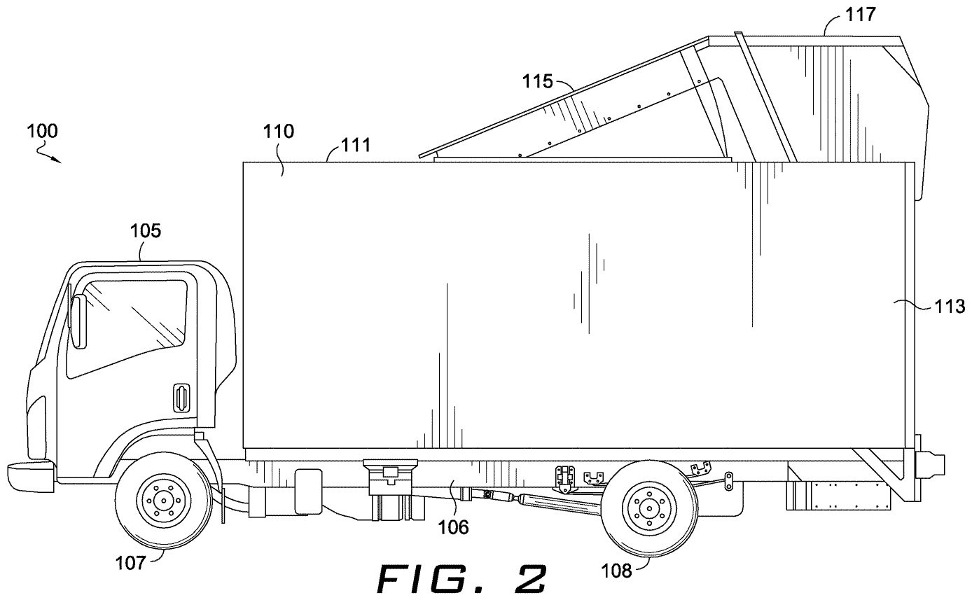

FIG. 2 depicts a side elevation view of the collection vehicle of FIG. 1, showing a raised retractable roof system, in accordance with examples of this disclosure.

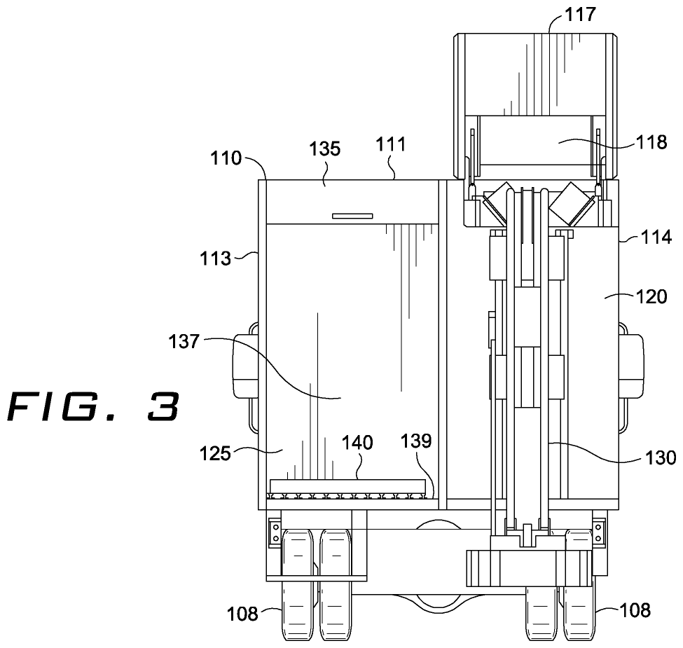

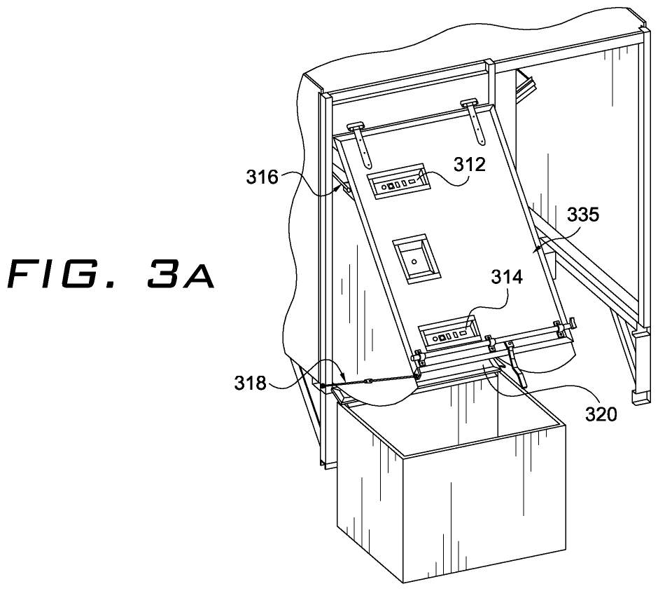

FIG. 3 depicts a rear elevation view of the collection vehicle of FIG. 2, showing a raised retractable roof system and showing a cargo collection and unloading section, in accordance with examples of this disclosure.

FIG. 3A depicts an example of a door for a collection vehicle.

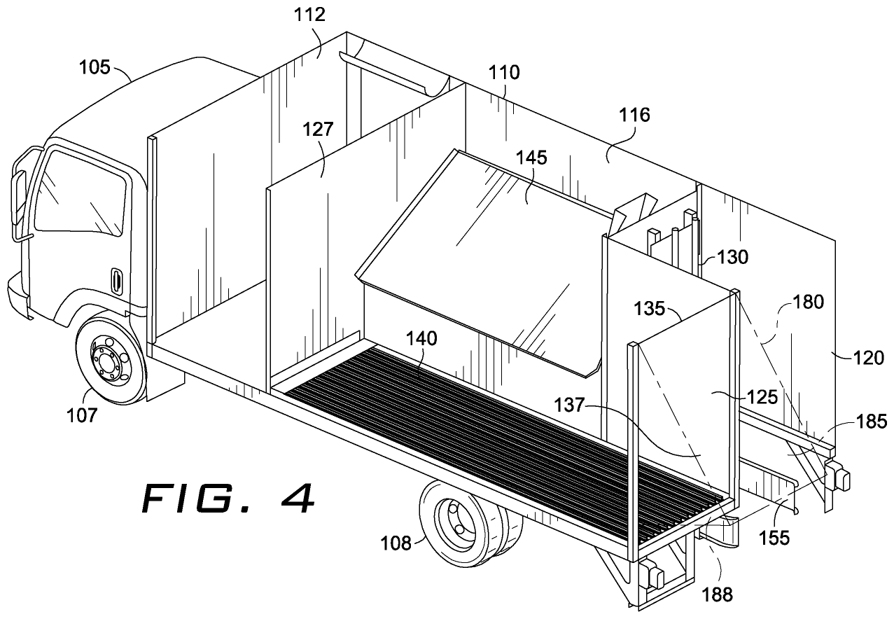

FIG. 4 depicts a perspective open view of the collection vehicle of FIG. 1, showing interior components of a cargo collection area and unloading section, in accordance with examples of this disclosure.

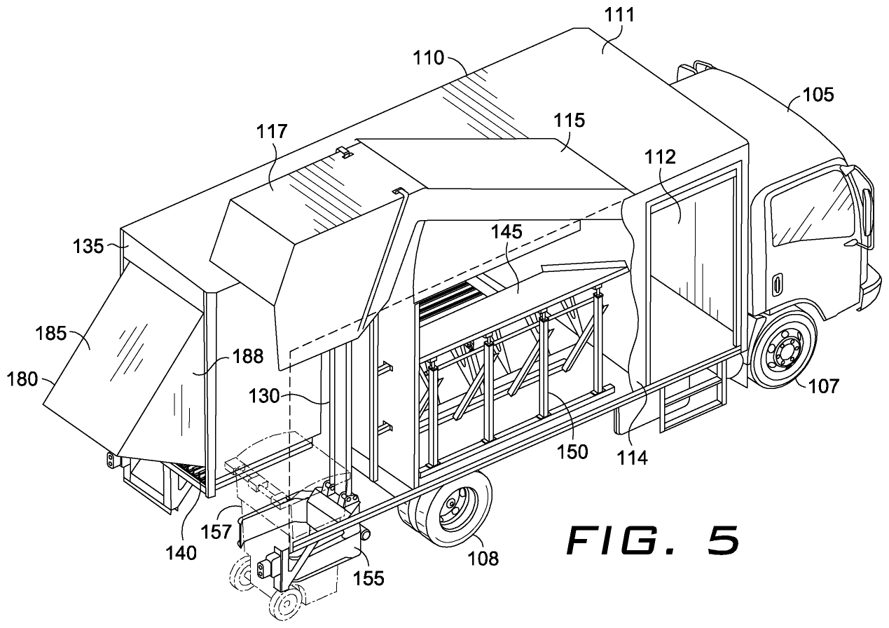

FIG. 5 depicts a perspective cut away view of the collection vehicle of FIG. 1, showing interior components of a cargo loading section, in accordance with examples of this disclosure.

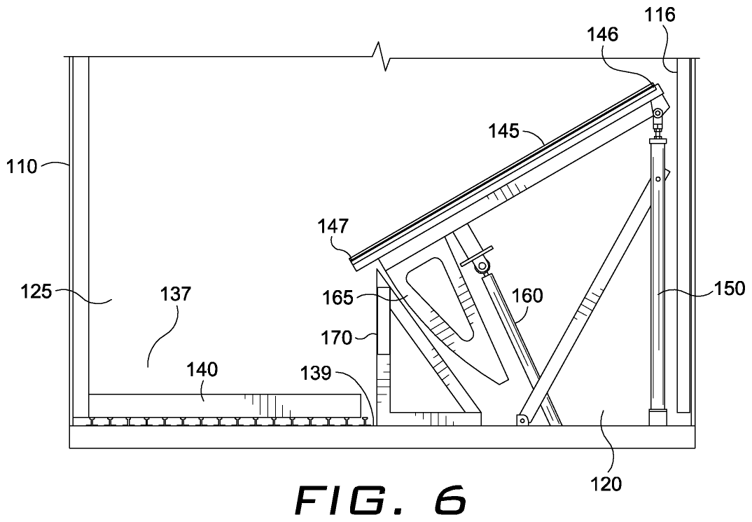

FIG. 6 depicts a rear elevation view of a material handling ramp assembly and cargo collection area of the collection vehicle of FIG. 1, in accordance with examples of this disclosure.

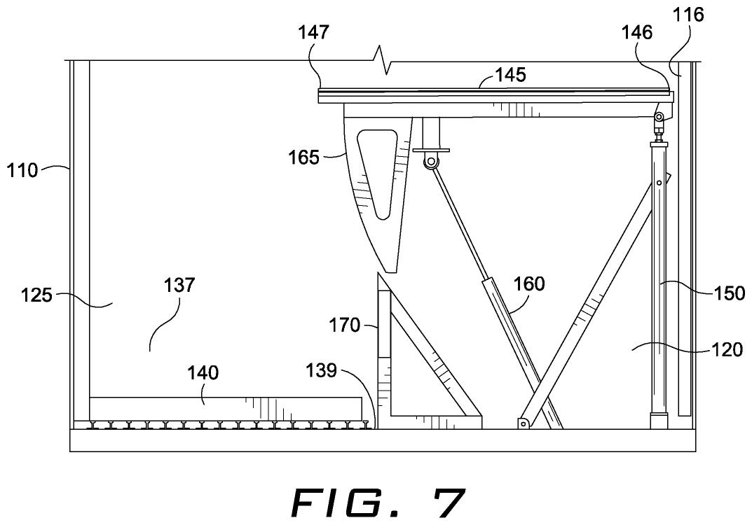

FIG. 7 depicts a rear elevation view of a material handling ramp assembly and cargo collection area of the collection vehicle of FIG. 1, in accordance with examples of this disclosure.

### DETAILED DESCRIPTION

This detailed description is related to a collection vehicle with improved loading and unloading. At a high level, a collection vehicle (e.g., collection truck) is disclosed providing for both loading and unloading to and from the rear of the vehicle. Thus, the collection vehicle may be backed to a raised or ground level loading dock, facility or open space for loading and unloading which eliminates the need for space along the side of the vehicle for loading or unloading and which eliminates the problem of cargo falling to the side of the vehicle and possible underneath the side of the vehicle.

With some conventional collection vehicles (e.g., trucks), a bin lifter might pick up a bin containing material on the side of the vehicle, load or dump the material into a collection portion in the back of the vehicle (e.g., an enclosed cargo area) and then unload or discharge the paper out of the rear of the collection portion. In other conventional examples, a bin lifter might pick up a bin containing material from the rear of the vehicle, load or dump the paper into a collection portion in the back of the vehicle (e.g., an enclosed cargo area), and then unload or discharge the material from the side of the collection portion. With either side loading or side unloading, parking the vehicle for loading or unloading is rendered difficult owing to the need for adequate space for the loading and/or unloading operation. That is, the operator of the vehicle must keep adequate space on the loading/unloading side of the vehicle to allow for movement and dumping of collection bins, boxes, bags, and the like and for subsequent unloading of the collection vehicle, particularly where an unloading vehicle such as a forklift is required. Having such space may be limited or even impossible if the vehicle is being operated in a busy urban area or where the vehicle must be maneuvered between other similar vehicles in a loading/unloading area of a building, warehouse, etc. Moreover, with either side loading or side unloading collection vehicles, often material (e.g., paper) being loaded or unloaded falls to the ground and is swept under the vehicle and potentially between the forward and rear axles of the vehicle. Such occurrences lead to unnecessary expenditure of operator work, and the need to collect such material is particularly problematic if the material contains confidential information (e.g., confidential documents being transported to a destruction facility).

In examples of the present disclosure, a collection vehicle that can load and unload from the rear may include a cargo compartment that is divided into two side-by-side sections. One of the sections operates as a loading section and the other section operates as an unloading section. The two sections run from a forward end of the cargo compartment to a rear end of the cargo compartment. The two sections may occupy equal space in the cargo compartment, or one section may occupy a larger space in the cargo compartment as needed for a given type of cargo collection. According to one example, the separation between the two sections is near a longitudinal midline of the cargo compartment.

The loading section includes a bin tipper at the rear end of the section. The bin tipper can releasably connect to a collection bin and dump the contents of the collection bin into the loading section. Inside the loading section, a cargo handling ramp is positioned onto which contents of the captured bin are dumped. The cargo handling ramp can be angled downward toward the unloading section of the cargo compartment positioned beside the loading section. As cargo is dumped from a tipped bin, the cargo falls onto the cargo handling ramp and then slides or falls down the ramp into the unloading section.

In at least some examples, the cargo handling ramp is positioned inside the cargo loading section forward of the bin tipper extending toward the forward end of the cargo compartment. The cargo handling ramp is further positioned under a discharge position of the bin tipper for receiving cargo as a captured bin is tipped into the loading section at the rear end of the loading section. According to some examples, the cargo handling ramp includes an outer edge and an inner edge, the outer edge being disposed closer to an inner surface of an outer side or wall of the loading section and the inner edge being disposed between the loading and unloading sections of the cargo compartment running longitudinally from the bin tipper toward the forward end of the cargo compartment. The inner edge of the cargo handling ramp may be disposed along a longitudinal midline of the cargo compartment between the loading and unloading sections of the cargo compartment.

When material or cargo is being dumped into the collection vehicle, the cargo handling ramp can be disposed at an angle, such that the inner edge of the cargo handling ramp is angled downward (relative to the outer edge of the cargo handling ramp) and toward a cargo receiving area in the unloading section, which can allow cargo dumped onto the ramp to readily fall or slide off the ramp and into the cargo receiving area. According to at least some examples, the cargo handling ramp is configured for disposition at one or more different angles between the inner edge and the outer edge. Thus, the ramp may be adjusted to different angles to facilitate efficient movement of cargo from the ramp into the cargo receiving area.

In at least some examples, a lift assembly is provided and is configured for moving the inner edge of the cargo handling ramp to the one or more different angles between the inner edge and the outer edge. The lift assembly may be positioned under the cargo handling ramp, or alternatively, the lift assembly may be positioned above the cargo handling ramp for lifting the ramp to different angles. The lift assembly may be manual or automatic, for example, a hydraulic or pneumatic lift. After a given load of cargo is moved from the cargo handling ramp to the cargo receiving area, the inner edge of the ramp may be moved up to allow dumped cargo to be efficiently removed from the cargo receiving area or to make room for additional cargo to be moved into the cargo receiving area or to be stored on top of the cargo handling ramp.

The unloading section of the cargo compartment includes an unloading access point or door at the rear end of the cargo compartment to allow collected material to be unloaded through the rear end of the vehicle. According to examples, the unloading section includes a cargo receiving area for receiving cargo, and the cargo receiving area includes a cargo receiving floor positioned below the inner edge of the cargo handling ramp onto which cargo is loaded from the cargo handling ramp. The cargo receiving floor may include a conveyor or moving floor configured for moving cargo loaded onto the cargo receiving floor toward the unloading access point or door.

In some examples, the cargo compartment of the cargo vehicle includes a roof covering the loading and unloading sections of the cargo compartment. A retractable portion of the roof over the loading section may be provided for allowing a bin tipper to raise a captured cargo bin above the height of the cargo vehicle for allowing a tipped bin to tip above the cargo handling ramp and to maximize the amount of cargo that may be loaded into the cargo compartment. The retractable portion is movable up and above the bin tipper when the bin tipper is raised to a position above the roof covering the loading and unloading sections of the cargo compartment. The retractable portion may return down after the bin is tipped to allow the roof covering to be returned to a pre-lifted position.

These and other aspects are described further below with reference to the accompanying drawings. The drawings are merely example implementations, and should not be construed to limit the scope of the claims. For example, while the example vehicles are shown and described as being heavy-duty or medium-duty trucks, aspects described herein can be used with a variety of other vehicle sizes, classes, and types (e.g., light duty trucks and other passenger vehicles, buses, trams, carts, and the like). In addition, the subject matter of this disclosure can be used with internal combustion engine (“ICE”) vehicles, electric vehicles (“EV”), battery electric vehicles (“BEV”); hybrid electric vehicles (“HEV”), plug-in electric vehicles (“PHEV”), and with fuel-cell electric vehicles (“FCEV”), among others.

As used herein, the terms “about” and “substantially” mean +/−10% of a given value, such as a dimensional value (e.g., height, width, etc.). In addition, with respect to an angle, or the terms parallel and perpendicular, the terms “about” and “substantially” mean within 10 degrees. If “about” or “substantially” are otherwise used, the terms can, where appropriate, include equivalents of the modified element.

Referring now to FIG. 1, FIG. 1 depicts a side elevation view of a collection vehicle 100 that may be loaded and unloaded from the rear end of the collection vehicle. According to examples, the collection vehicle 100, illustrated in FIG. 1, includes a vehicle cab 105 for carrying a vehicle operator and one or more passengers. The vehicle cab 105 also may contain control equipment (not illustrated) such as vehicle steering, gear selection, acceleration and braking pedals, as well as, gauges for showing vehicle performance information.

A chassis 106 is illustrated onto which the vehicle cab 105 and vehicle cargo compartment 110 are attached. A wheel, tire and axle assembly 107 is illustrated under the forward section of the chassis 106 and vehicle cab 105 for supporting a forward end of the collection vehicle 100. A wheel, tire and axle assembly 108 is illustrated under a rear section of the chassis 106 for supporting the rear section of the chassis 106 and the cargo compartment 110 mounted on top of the chassis 106. As should be appreciated, the configuration of the vehicle 100, illustrated in FIG. 1, is for purposes of illustration only and is not limiting of a variety of different vehicle configurations that may be utilized in accordance with examples of the present disclosure. For example, additional wheel, tire and axle assemblies 108 may be included in association with the rear section of the chassis 106 for supporting heavier loading or a longer chassis 106. In addition, according to other examples, the cargo compartment 110 may be mounted on a trailer that is attached to a separate cab 105 to allow the trailer to articulate relative to the cab 105 as required for various uses of the collection vehicle 100.

Referring now to FIG. 2, FIG. 2 depicts a side elevation view of the collection vehicle of FIG. 1, showing a raised retractable roof system, in accordance with examples of this disclosure. In examples, the cargo compartment 110 includes a cargo compartment roof 111 and a first cargo compartment side or wall 113 on the left side of the cargo compartment 110 (facing forward toward the collection vehicle cab 105). As described in further detail below with reference to FIG. 3, a retractable roof system 115 may raise above the cargo compartment roof 111 to allow for a collection bin to be raised above the surface of the cargo compartment roof 111 for discharging or dumping the contents of the collection bin into the cargo compartment 110. The retractable roof system 115 includes a collection bin receiving structure 117. The bin receiving structure 117 provides for a chamber into which a collection bin may be raised for discharging or dumping the contents of the collection bin into the cargo compartment 110.

Referring now to FIG. 3, FIG. 3 depicts a rear elevation view of the collection vehicle of FIG. 2, showing a raised retractable roof system and showing a cargo collection and unloading section. According to examples of the present disclosure, the cargo compartment 110 is divided into two side-by-side sections 120, 125. The two sections 120, 125 run from a forward end 127 (see FIG. 4) of the cargo compartment 110 to a rear end of the cargo compartment 110. The two sections 120, 125 may occupy equal space in the cargo compartment 110, or one section may occupy a larger space in the cargo compartment 110 as needed for a given type of cargo collection. According to one example, the separation between the two sections 120, 125 may run near a longitudinal midline of the cargo compartment 110. According to one example, the longitudinal midline may can include +/−10% of the width of the cargo compartment 110. According to examples, the first section 120 illustrated on a right side of the cargo compartment 110 (facing forward toward the vehicle 105) is operated as a loading section of the cargo compartment 110, and the second section 125 illustrated on the left side of the cargo compartment 110 (facing forward toward the cargo vehicle cab 105) is configured for receiving cargo loaded into the cargo compartment 110 via the loading section 120. As should be appreciated, the orientation of the loading section 120 on the right side of the cargo compartment 110 and the unloading section 125 on the left side of the cargo compartment 110 is for purposes of illustration only as the orientation of the two sections 120, 125 may be reversed as required or as needed for use of the cargo collection vehicle 100 in one or more different loading and unloading environments.

In examples, the loading section 120 of the cargo compartment 110 includes a side or wall 114 on the right side of the cargo compartment 110 (facing forward toward the cargo vehicle cab 105. A bin tipper system 130 is configured at the rear end of the loading section 120 inside the side or wall 114 of the cargo compartment 110. According to examples, the bin tipper system 130 is configured to releasably connect to a collection bin 157 (see FIG. 5) to discharge or dump contents of the collection bin into the loading section 120 of the cargo compartment 110.

Referring still to FIG. 3, the unloading section 125 of the cargo compartment 110 includes a cargo receiving area 137 over a cargo receiving area floor 139. A cargo conveyor or moving floor 140 is illustrated on the cargo receiving area floor 139 for moving cargo to the rear end of the cargo compartment 110 for unloading through the rear end of the cargo receiving and unloading section 125. According to examples, a cargo unloading access 135 is illustrated. According to the example illustrated in FIG. 3, the cargo unloading access 135 is in the form of a door that may be raised for unloading cargo from the cargo unloading section 125 or that may be lowered for closing the cargo unloading section 125 during cargo loading and transit. As should be appreciated, the cargo unloading access 135 may include other opening arrangements, for example, a hinged door that may be opened outward from the rear end of the cargo compartment 110 for unloading cargo loaded into the cargo unloading section 125.

Referring to FIG. 3A, an example door 335 is depicted, which includes a door panel that is hingedly coupled near the opening to the cargo unloading section 125. For example, the door panel can be attached via a hinge near the top of the opening. In some examples, the door panel can be attached via a hinge along a side of the opening.

The door 335 can have various features. For example, the door 335 can include a lever 310 or other type of handle or actuator for locking and unlocking the door 335. In addition, the door 335 can include one or more control units 312 and 314 for controlling operations associated with the vehicle, such as bin tipper operations, adjustments of the ramp 145, shredding (if some cases), walking floor, and the like. In some examples, a first control unit 312 is positioned higher and provides convenient controls access when an operator is standing on a dock, and a second control unit 314 is positioned lower and provides convenient controls access for an operator on the ground.

In at least some examples, the door 335 can be associated with a gas or pneumatic door assist 316 that can reduce the manual force required to open or close the door. In addition, the door 335 can be associated with a locking bar 318 that locks out when the door 335 is opened, to reduce the likelihood of inadvertent closing.

In at least some instances, a transition flap 320 can be hingedly coupled to near the opening to the cargo unloading section 125, such as near a lower portion of the cargo unloading section 125. Among other things, the transition flap 320 can rotate between a stowed position (e.g., rotated upward) and a deployed position (e.g., rotated downward and at least partially covering a gap or space between the cargo unloading section and a receptacle positioned to receive the paper unloaded from the back of the vehicle). As such, the transition flap 320 can reduce the likelihood of paper spillage out of the receptacle. In the stowed position, the transition flap can either be positioned internal to the door 335, or the transition flap 320 can be retained in position on the outside of the door 335, such as in coordination with the lock or with another locking or retention mechanism.

Referring now to FIG. 4, FIG. 4 depicts a perspective open view of the collection vehicle of FIG. 2, showing interior components of a cargo collection area and unloading section, in accordance with examples of this disclosure. For purposes of illustration, FIG. 4 shows the cargo compartment without the side or wall 113 and roof 111 for illustrating interior components of the loading section 120 and the unloading section 125 of the cargo compartment 110. As illustrated in FIG. 4, an optional forward storage compartment 112 is provided that may be used according to a variety of example uses. For example, the optional forward compartment 112 may be used to store cargo that must be segregated from cargo stored in the unloading section 125. Alternatively, the optional forward storage compartment 112 may be used to store or operate equipment, for example, loading and unloading service vehicles, paper shredding equipment, or a variety of tools for use in loading, unloading and disposing of cargo. As should be appreciated, the optional forward storage compartment 112 is shown for purposes of illustration only, and the cargo compartment 110 may or may not include the optional forward storage compartment 112 as required for the needs of various uses of the cargo vehicle 100.

Referring still to FIG. 4, the interior of the cargo compartment 110 includes a forward inner surface wall 127 and a right-side inner surface wall 116 (facing toward the cab 105). According to an example, the cargo loading section 120 is illustrated running forward from the bin tipper system 130 toward the inner surface wall 127 and inside the right-side inner surface wall 116. The cargo unloading section 125 is illustrated running from a rear end of the cargo compartment 110 forward toward the forward inner surface 127. As illustrated in FIG. 4, the two side-by-side (loading and unloading) sections 120, 125 occupy the same or similar space in the cargo compartment 110 and are separated at or near a longitudinal midline of the cargo compartment 110. According to examples, the longitudinal midline can include +/−10% of the width of the cargo compartment 110. However, according to other examples, the space occupied by the two cargo sections 120, 125 may vary according to the needs of a given cargo environment.

According to an example of the present disclosure, a cargo handling ramp 145 is positioned inside the loading section 120 for dumping cargo into the unloading section 125 for subsequent unloading through the rear end of the unloading section 125. As illustrated in FIG. 4, the cargo handling ramp is disposed in an angled orientation toward the cargo receiving area 137 of the cargo unloading section 125 enabling cargo discharged onto or dumped onto the cargo handling ramp 145 to slide or fall into the cargo receiving area 137 and onto the cargo conveyor 140 of the unloading section 125 of the cargo compartment 110. According to one example, the cargo conveyor 140 is disposed on a floor of the cargo unloading section 125 for moving cargo dumped onto the cargo conveyor 140 to the rear of the cargo compartment 110 and out of the unloading access 135. That is, according to examples, as a collection bin is captured by the bin tipper system capturing clamps 155 and is raised above the top of the cargo compartment 110 under the retractable structure 115 and 117 (illustrated in FIGS. 1-3, 5), the contents of the collection bin may be dumped or otherwise discharged onto the cargo handling ramp 145 to allow the cargo to fall or slide into the cargo receiving area 137 of the unloading section 125 of the cargo compartment 110.

Referring now to FIG. 5, FIG. 5 depicts a perspective cut away view of the collection vehicle of FIG. 1, showing interior components of the cargo loading section 120 including the bin tipper system 130, in accordance with examples of this disclosure. The bin tipper system 130 is operative to capture a collection bin 157 (illustrated in phantom) using releasable bin capturing clamps 155. After a collection bin 157 is captured, the collection bin 157 is raised using the bin tipper system 130 to a position above the roof 111 of the cargo compartment 110 inside the raised retractable roof structure 117 of the retractable roof system 115. Once the captured collection bin 157 is raised to a position above the roof 111 of the collection vehicle cargo compartment 110, the bin tipper system 130 may tip the bin in the direction of the cargo handling ramp 145 for discharging or dumping the contents of the captured collection bin onto the cargo ramp the cargo handling ramp 145. Once the contents of the collection bin 157 are discharged or dumped onto the cargo handling ramp 145, the contents the cargo dumped onto the ramp 145 may slide or fall into the collection area of the unloading section 125 and onto the cargo conveyor 140.

In at least some examples, the vehicle can be equipped with a chute or other ramp or angled surface that is associated with the bin tipper and that operates to distribute contents to a forward part of the handling ramp (e.g., closer to the front or cab of the vehicle). For example, the angled surface can be fixed above the ramp or can be part of the bin tipper, and when the bin tipper dumps the contents, the contents can slide along the angled surface towards a front of the vehicle before falling down to the ramp 145.

Referring still to FIGS. 4 and 5, according to examples, an optional overhead cargo directional unloading chute 180 is provided. The overhead cargo directional unloading chute 180, illustrated in phantom in FIG. 4 and in solid in FIG. 5, includes a top panel 185 and two opposing side panels 188. According to examples, the overhead cargo directional unloading chute 180, provides for directing cargo from the rear end of the cargo receiving and unloading section 125. When the cargo access door 135 is opened either by raising the cargo access door 135 or by opening the cargo access door 135 laterally in the case of a hinged cargo access door 135, the overhead cargo directional chute 180 may be deployed, as illustrated in FIG. 5, to direct cargo from the cargo receiving and unloading section 125. As should be appreciated, when cargo is unloaded from the cargo receiving and unloading section 125, it may be difficult to direct the cargo onto a specific area of a loading dock, conveyor or the like, or it may be difficult to direct the cargo into an awaiting cargo container, for example, a bin, tub or the like. Indeed, some of the cargo, for example, loose paper, may fall out of the sides of the cargo container 110 onto the ground or under the cargo compartment 110. According to examples, the overhead cargo directional chute 180 allows cargo to be directed to a specific unloading destination as desired. According to one example, when the overhead cargo directional chute 180 is not deployed, it may be rotatably moved into the interior of the rear end of the cargo receiving and unloading section 125 to allow the cargo access door 135 to be closed behind it. When the cargo access door 135 is opened for unloading cargo, the overhead cargo directional chute may be deployed outward, as illustrated in FIG. 5, either manually, or automatically via a motorized actuator (not shown).

Referring still to FIG. 5, according to another example, the overhead cargo directional chute 180 and the cargo access door 135 may be integrated such that the top panel 185 replaces the cargo access door 135. For example, the top panel 185 can include the door 335. According to this example, when the overhead cargo directional chute 180 is not deployed, the top panel 185 closes the rear end of the cargo receiving and unloading section 125. When, the overhead cargo directional chute 180 is deployed, the rear end of the cargo receiving and unloading section 125 is opened.

Referring now to FIG. 6, FIG. 6 depicts a rear elevation view of a material handling ramp assembly and cargo collection area of the collection vehicle of FIG. 1, in accordance with examples of this disclosure. As illustrated in FIG. 6, the cargo handling ramp 145 includes a generally planar upper surface and includes an outer edge 146 and an inner edge 147. The outer edge 146 of the cargo handling ramp 145 is disposed closer to an inner surface 116 of an outer side or wall 114 of the loading section 120 of the cargo compartment 110. According to examples, the inner edge 147 of the cargo handling ramp 145 is disposed between the loading section 120 and the unloading section 125 of the cargo compartment 110 and runs longitudinally from the bin tipper system 130 toward the forward end 127 of the cargo compartment 110 (see FIG. 4). The inner edge 147 is further positioned adjacent to and over the cargo receiving area 137 of the cargo unloading section to allow cargo on the ramp 145 to slide or fall directly into the cargo receiving area 137. According to one example, the inner edge 147 of the cargo handling ramp 145 may be disposed along a longitudinal midline of the cargo compartment 110 between the loading section 120 and the unloading section 125. As illustrated in FIGS. 4 and 5, the planar upper surface of the ramp 145 is disposed underneath a discharge or dumping position of the bin tipper system 130 to allow contents of the bin 157 to be discharged or dumped onto the upper planar surface of the ramp 145.

Referring still to FIG. 6, a lift assembly 150 is provided and is configured for moving the inner edge 147 of the cargo handling ramp 145 to one or more different angles between the inner edge 147 and the outer edge 146. According to one example, the cargo handling ramp 145 is initially configured with the inner edge 147 angled downward from the outer edge 146 so that cargo dumped onto the ramp 145 will slide or fall into the cargo receiving area 137. However, as described herein, the angular orientation of the cargo handling ramp 145 may be changed as cargo loading and unloading conditions require. In examples, as illustrated in FIG. 6, the lift assembly 150 is configured underneath the ramp 145 for changing the angular orientation of the ramp 145.

According to the examples illustrated in FIG. 6, a lift mechanism 160 is disposed for pushing the inner edge of the cargo handling ramp 145 through various angles from a downward angle, illustrated in FIG. 6, to other angles, as illustrated and described below with reference to FIG. 7. In examples, the lift mechanism 160 may be a manual lift mechanism requiring manual actuation by an operator, or the lift mechanism may be an automatic lift mechanism, for example, a hydraulic or pneumatic system. A pair of guide structures 165, 170 are illustrated for guiding movement of the cargo handling ramp 145 through various angles. As illustrated in FIG. 6, a lower guide structure 170 is affixed to the floor 139 of the cargo compartment 110 and a ramp guide 165 is affixed to a lower surface of the ramp 145 for guiding movement of the ramp relative to the lower guide structure 170 as the cargo ramp 145 is moved through different angular orientations. As should be understood, illustration of the ramp lift assembly 150 is for purposes of illustration only and is not limiting of other suitable mechanisms for changing the angular orientation of the cargo handling ramp 145. That is, according to an example, the lift mechanism 160 may be positioned on the upper surface of the ramp 145 and may be affixed to an inner surface of the roof structure 111 of the cargo compartment 110 for lifting the cargo handling ramp 145 through various angular orientations according to examples of the present disclosure.

As described above, cargo dumped onto or discharged onto the cargo handling ramp 145 either manually or by the bin tipper system 130 falls onto the cargo handling ramp 145 and then falls from or slides from the downward oriented cargo ramp 145 into the cargo receiving area 137 and onto the cargo conveyor 140 positioned on the floor 139 of the unloading section 125 of the cargo compartment 110. Referring now to FIG. 7, the cargo handling ramp is illustrated as moved to a horizontal position where the inner edge 147 is positioned in horizontal alignment with the outer edge 146. As should be appreciated, the angular orientation of the cargo handling ramp 145, illustrated in FIG. 7, is an illustrative example of an angular orientation of the cargo handling ramp 145 and is not limiting of other angular orientations that may be utilized according to examples of the present disclosure. That is, the angular orientation of the cargo ramp 145 may be manually or automatically adjusted to facilitate varying loading and unloading conditions, as described below.

According to examples, after a given load of cargo is discharged or dumped onto the cargo handling ramp 145, the dumped cargo may slide or fall from the downwardly angled cargo ramp 145 (see FIG. 6) and into the cargo receiving area 137 of the unloading section 125. In order to ensure all cargo dumped onto the cargo handling ramp 145 slides or falls into the cargo receiving area 137, the cargo handling ramp 145 may be actuated upward and downward to urge cargo resting on the cargo handling ramp 145 to slide or fall into the cargo receiving area 137 and onto the cargo conveyor 140. In addition, by moving the cargo handling ramp 145 to different angular orientations, as illustrated in FIG. 7, additional cargo may be deposited into the cargo receiving area 137 onto the cargo conveyor 140. That is, as cargo is moved into the cargo receiving area 137 from the cargo ramp 145, the cargo handling ramp 145 may be raised to different angular orientations to allow for additional cargo to fall into the cargo receiving area 137. In addition, after the cargo receiving area is completely filled with cargo by moving cargo into the cargo receiving area from the cargo handling ramp 145, the cargo handling ramp 145 may be moved to a different angular orientation, for example, the horizontal angular orientation, illustrated in FIG. 7, and additional cargo may then be dumped onto the cargo handling ramp 145 until cargo fills the cargo compartment 110 above the surface of the cargo handling ramp 145 and onto cargo presently contained in the adjacent cargo receiving area 137.

According to examples, when cargo is subsequently unloaded from the cargo unloading section 125, cargo may be moved out of the cargo receiving area 137 manually or by utilizing the cargo conveyor 140. As cargo is moved from the cargo receiving area 137 through the rear unloading access 135 of the unloading section 125, cargo presently resting on the surface of the cargo ramp 145 may be urged into the cargo receiving area 137 by actuating the cargo ramp 145 back to an angular orientation, as illustrated in FIG. 6. Thus, any cargo presently resting on the surface of the cargo handling ramp 145 may slide or fall into the cargo receiving area 137 as space becomes available in the cargo receiving area 137 by unloading cargo from the cargo receiving area 137 of the unloading section 125.

As described herein, and as illustrated in FIGS. 3-7, a cargo conveyor 140 may be disposed on the floor 139 of the unloading section 125. According to examples, the cargo conveyor 140 may be any suitable conveyor device such as a belt conveyor for moving cargo discharged or dumped onto the cargo conveyor 140. Alternatively, the cargo conveyor 140 may include other types of conveying systems such as a cargo walking floor comprised of a plurality of sections that may be actuated from the forward end of the cargo compartment 127 toward the rear end of the cargo compartment 110 for moving cargo contained or disposed on the cargo conveyor 140 toward the rear end of the unloading section 125 and out of the cargo access point 135. As should be appreciated, use of a cargo conveyor 140 is for purposes of illustration only as cargo may be removed from the unloading section 125 without the use of a cargo conveyor 140, for example, via manual unloading by one or more operators of the cargo vehicle 100.

### Example Clauses

A. A collection vehicle comprising a cargo compartment having first and second sections, the first and second sections positioned in side-by-side orientation and further positioned longitudinally from a forward end of the cargo compartment to a rear end of the cargo compartment; a bin tipper positioned at a rear of the first section; and an unloading access positioned at a rear of the second section.

B. The collection vehicle of Clause A, the bin tipper being positioned adjacent to the unloading access.

C. The collection vehicle of Clause A further comprising a cargo receiving area positioned inside the second section of the cargo compartment forward of the unloading access.

D. The collection vehicle of Clauses A and C further comprising a cargo handling ramp positioned inside the first section of the cargo compartment forward of the bin tipper.

E. The collection vehicle of Clauses A, C and D wherein the cargo handling ramp is further positioned under a discharge position of the bin tipper.

F. The collection vehicle of Clauses A, C and D wherein the cargo handling ramp comprises an outer edge and an inner edge; the outer edge being disposed, as compared to the inner edge, closer to an outer side of the first section of the cargo compartment; and the inner edge being disposed, as compared to the outer edge, closer to the second section.

G. The collection vehicle of Clauses A and C through F, the inner edge being further disposed between the first and second sections of the cargo compartment running longitudinally from the bin tipper toward the forward end of the cargo compartment.

H. The collection vehicle of Clauses A and C through G wherein the inner edge of the cargo handling ramp is disposed along a longitudinal midline of the cargo compartment between the first and second sections of the cargo compartment.

I. The collection vehicle of Clauses A and C through E wherein the cargo handling ramp is disposed at an angle with the inner edge of the cargo handling ramp being positioned lower than the outer edge of the cargo handling ramp.

J. The collection vehicle of Clauses A, C through E and I wherein the cargo handling ramp is selectively movable to one or more different angles between the inner edge and the outer edge.

K. The collection vehicle of Clauses A, C through E, I and J wherein, to selectively move the cargo handling ramp to the one or more different angles, the cargo handling ramp comprises a lift configured for moving the inner edge to one or more different positions relative to the outer edge.

L. The collection vehicle of Clauses A, C through E and I through K wherein the lift is positioned under the cargo handling ramp.

M. The collection vehicle of Clauses A, C through E and I through K wherein lift is a manual lift.

N. The collection vehicle of Clauses A, C through E and I through K wherein the lift is an automatic lift.

O. The collection vehicle of Clauses A, C through E wherein the cargo receiving area comprises a cargo receiving floor positioned below the inner edge of the cargo handling ramp, the cargo receiving floor including a conveyor configured for moving cargo loaded onto the cargo receiving floor toward the unloading access.

P. The collection vehicle of Clause A further comprising an overhead cargo directional chute configured for directing cargo from the unloading access positioned at a rear of the second section.

Q. The collection vehicle of Clause A wherein the cargo compartment comprises a roof covering the first and second sections of the cargo compartment; and a retractable portion of the roof over the first section, the retractable portion movable up and above the bin tipper when the bin tipper is raised to a position above the roof covering the first and second sections of the cargo compartment.

R. A collection vehicle, comprising a cargo compartment having loading and unloading sections, the loading and unloading sections positioned in side-by-side orientation and further positioned longitudinally from a forward end of the cargo compartment to a rear end of the cargo compartment; a bin tipper positioned at a rear end of the loading section; an unloading door positioned at a rear end of the unloading section and further positioned adjacent to the bin tipper; a cargo receiving area positioned inside the unloading section of the cargo compartment forward of the unloading door; and a cargo loading ramp positioned inside the loading section of the cargo compartment forward of the bin tipper, the cargo loading ramp being selectively movable between one or more angles from an outer side of the loading section toward the cargo receiving area of the unloading section.

S. The collection vehicle of Clause R wherein the cargo receiving area comprises a cargo receiving floor positioned below an inner edge of the cargo loading ramp onto which cargo is loaded from the cargo loading ramp; and a conveyor configured for moving cargo loaded onto the cargo receiving floor toward the unloading door.

T. A cargo vehicle, comprising a cargo compartment having first and second sections, the first and second sections positioned in side-by-side orientation along a longitudinal midline of the cargo compartment from a forward end of the cargo compartment to a rear end of the cargo compartment; a bin tipper positioned at a rear end of the first section; an unloading access positioned at a rear end of the second section; a cargo handling ramp positioned inside the first section of the cargo compartment forward of the bin tipper under a discharge position of the bin tipper, the cargo handling ramp being disposed at an angle wherein an inner edge of the cargo handling ramp running along the longitudinal midline of the cargo compartment is selectively angled downward relative to an outer edge of the cargo handling ramp toward a cargo receiving area positioned inside the second section of the cargo compartment; and a cargo conveyor disposed on a floor of the cargo receiving area configured for moving cargo loaded onto the cargo receiving area from the cargo handling ramp toward the unloading access.

U. The vehicle of any of Clauses A through T further comprising, a door controlling access to the unloading portion or section.

V. The vehicle of Clause U, wherein the door comprises an outer, rear wall of a deployable chute.

W. The vehicle of Clause U or Clause V, wherein the door hingedly attaches to a top of the unloading portion or section.

X. The vehicle of any of Clauses U through W, wherein the door comprises a gas or pneumatic assist, a locking bar.

Y. The vehicle of any of Clauses A through X further comprising, a transition flap that rotatably attaches near a lower portion of an opening to the unloading portion or section.

Z. The vehicle of Clause Y, wherein the transition flap is configured to move between a stowed position and a deployed position, and wherein in the deployed position the transition flap spans a distance between the vehicle and a receptacle.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

Claimed is:

1. A collection vehicle comprising:
a cargo compartment having first and second sections, the first and second sections positioned in side-by-side orientation and further positioned longitudinally from a forward end of the cargo compartment to a rear end of the cargo compartment;
a bin tipper positioned at a rear of the first section; and
an unloading access positioned at a rear of the second section.

2. The collection vehicle according to claim 1, the bin tipper being positioned adjacent to the unloading access.

3. The collection vehicle according to claim 1, further comprising a cargo receiving area positioned inside the second section of the cargo compartment forward of the unloading access.

4. The collection vehicle according to claim 3, further comprising a cargo handling ramp positioned inside the first section of the cargo compartment forward of the bin tipper.

5. The collection vehicle according to claim 4, wherein the cargo handling ramp is further positioned under a discharge position of the bin tipper.

6. The collection vehicle according to claim 4, wherein the cargo handling ramp comprises:
an outer edge and an inner edge;
the outer edge being disposed, as compared to the inner edge, closer to an outer side of the first section of the cargo compartment; and
the inner edge being disposed, as compared to the outer edge, closer to the second section.

7. The collection vehicle according to claim 6, the inner edge being further disposed between the first and second sections of the cargo compartment running longitudinally from the bin tipper toward the forward end of the cargo compartment.

8. The collection vehicle according to claim 7, wherein the inner edge of the cargo handling ramp is disposed along a longitudinal midline of the cargo compartment between the first and second sections of the cargo compartment.

9. The collection vehicle according to claim 6, wherein the cargo handling ramp is disposed at an angle with the inner edge of the cargo handling ramp being positioned lower than the outer edge of the cargo handling ramp.

10. The collection vehicle according to claim 9, wherein the cargo handling ramp is selectively movable to one or more different angles between the inner edge and the outer edge.

11. The collection vehicle according to claim 10, wherein, to selectively move the cargo handling ramp to the one or more different angles, the cargo handling ramp comprises a lift configured for moving the inner edge to one or more different positions relative to the outer edge.

12. The collection vehicle according to claim 11, wherein the lift is positioned under the cargo handling ramp.

13. The collection vehicle according to claim 11, wherein lift is a manual lift.

14. The collection vehicle according to claim 11, wherein the lift is an automatic lift.

15. The collection vehicle according to claim 6, wherein the cargo receiving area comprises a cargo receiving floor positioned below the inner edge of the cargo handling ramp, the cargo receiving floor including a conveyor configured for moving cargo loaded onto the cargo receiving floor toward the unloading access.

16. The collection vehicle according to claim 1, further comprising an overhead cargo directional chute configured for directing cargo from the unloading access positioned at a rear of the second section.

17. The collection vehicle according to claim 1, wherein the cargo compartment comprises:
a roof covering the first and second sections of the cargo compartment; and
a retractable portion of the roof over the first section, the retractable portion movable up and above the bin tipper when the bin tipper is raised to a position above the roof covering the first and second sections of the cargo compartment.

18. A collection vehicle, comprising:
a cargo compartment having loading and unloading sections, the loading and unloading sections positioned in side-by-side orientation and further positioned longitudinally from a forward end of the cargo compartment to a rear end of the cargo compartment;
a bin tipper positioned at a rear end of the loading section;
an unloading door positioned at a rear end of the unloading section and further positioned adjacent to the bin tipper;
a cargo receiving area positioned inside the unloading section of the cargo compartment forward of the unloading door; and
a cargo loading ramp positioned inside the loading section of the cargo compartment forward of the bin tipper, the cargo loading ramp being selectively movable between one or more angles from an outer side of the loading section toward the cargo receiving area of the unloading section.

19. The collection vehicle according to claim 18, wherein the cargo receiving area comprises:
a cargo receiving floor positioned below an inner edge of the cargo loading ramp onto which cargo is loaded from the cargo loading ramp; and
a conveyor configured for moving cargo loaded onto the cargo receiving floor toward the unloading door.

20. A cargo vehicle, comprising:
a cargo compartment having first and second sections, the first and second sections positioned in side-by-side orientation along a longitudinal midline of the cargo compartment from a forward end of the cargo compartment to a rear end of the cargo compartment;
a bin tipper positioned at a rear end of the first section;
an unloading access positioned at a rear end of the second section;
a cargo handling ramp positioned inside the first section of the cargo compartment forward of the bin tipper under a discharge position of the bin tipper, the cargo handling ramp being disposed at an angle wherein an inner edge of the cargo handling ramp running along the longitudinal midline of the cargo compartment is selectively angled downward relative to an outer edge of the cargo handling ramp toward a cargo receiving area positioned inside the second section of the cargo compartment; and
a cargo conveyor disposed on a floor of the cargo receiving area configured for moving cargo loaded onto the cargo receiving area from the cargo handling ramp toward the unloading access.
